(19) United States
(12) Patent Application Publication
(10) Pub. No.: US 2012/0282063 A1
(43) Pub. Date: Nov. 8, 2012

(54) FASTENING ELEMENT STRIP

(75) Inventors: Markus Kieber, Schaanwald (DE); Elisabeth Malm, Stockholm (SE)

(73) Assignee: Hilti Aktiengesellschaft, Schaan (LI)

(21) Appl. No.: 13/461,417

(22) Filed: May 1, 2012

(30) Foreign Application Priority Data
May 2, 2011 (DE) 10 2011 075 085.1

(51) Int. Cl. F16B 15/08

(52) U.S. Cl. 411/443

(57) ABSTRACT

A strip for fastening elements, each having a shank and a head, and including a plurality of holding sections joined to each other so that each can temporarily hold a fastening element, whereby a first holding section has a receptacle for a shank of a fastening element, whereby the receptacle defines a fastening direction in which a fastening device can drive the fastening element out of the receptacle and into a substrate, and whereby the receptacle has a face opening on the head side that closes off the receptacle opposite from the fastening direction, and whereby an edge of the face opening on the head side is slanted at an acute angle with respect to the fastening direction.

This claims the benefit of German Patent Application DE 10 2011 075 085.1, filed May 2, 2011 and hereby incorporated by reference herein.

The invention relates to a strip for fastening elements, each having a shank and a head.

### BACKGROUND

Such strips normally comprise a plurality of holding sections joined to each other so that each one can temporarily hold a fastening element. Such a holding section comprises a receptacle for a shank or a head of each individual fastening element. While the fastening element is being driven into a substrate by means of a fastening device, the fastening element is pushed out of the receptacle or through the receptacle, for which purpose a certain amount of force has to be exerted. It can happen that the receptacle is destroyed in this process, as a result of which remnants of the receptacle can adhere to the fastening element.

### SUMMARY OF THE INVENTION

It is an objective of the invention to provide a strip with which the fastening elements can be individuated in a simple manner, and especially with only a small amount of force.

The present invention provides a strip for fastening elements, each having a shank and a head, and comprising a plurality of holding sections joined to each other so that each one can temporarily hold a fastening element. Here, a first holding section has a receptacle for a shank of the fastening element, whereby the receptacle defines a fastening direction in which a fastening device can drive the fastening element out of the receptacle and into a substrate. The strip has a continuous strip core, whereby the receptacle is arranged outside of the strip core. Preferably, the receptacle is in contact with the strip core. In an alternative embodiment, the receptacle is at a distance from the strip core and, in particular, it is joined to the strip via one or more webs.

In a preferred embodiment, the receptacle has a face opening on the head side that closes off the receptacle opposite from the fastening direction, whereby an edge of the face opening on the head side is slanted at an acute angle with respect to the fastening direction. The angle of inclination is smaller than a right angle, preferably between 20° and 85°, especially preferably between 30° and 80°. When the fastening element is moved in the fastening direction, the receptacle is gradually widened or bent open by the fastening element, preferably by the head or by a widening section of the fastening element, so that the fastening elements can be individuated in a simple manner.

A preferred embodiment is characterized in that the receptacle has a slit that adjoins the face opening on the head side. As a result, the force needed to individuate the fastening element can be reduced. Preferably, the slit extends along the fastening direction, especially preferably along the entire length of the receptacle.

A preferred embodiment is characterized in that the edge of the face opening on the head side extends from the slit opposite from the fastening direction. This means that the slit can be configured on the shorter side of the receptacle, which makes it easier for the fastening element to widen or bend open the receptacle.

A preferred embodiment is characterized in that the fastening element can be snapped into the receptacle. This makes it easy to mount the fastening element. Preferably, the fastening element is snapped into the receptacle all the way through the slit.

A preferred embodiment is characterized in that the receptacle is configured to be essentially cylindrical. Preferably, the shape of the receptacle is adapted to the shank of the fastening element.

A preferred embodiment is characterized in that the receptacle also has a face opening on the tip side that closes off the receptacle in the fastening direction. As a result, the fastening element comes out more easily during a driving procedure. Preferably, the face opening on the tip side adjoins the slit, so that the slit joins the two face openings to each other.

Preferably, an edge of the face opening on the tip side is slanted at an acute angle with respect to the fastening direction, so that the strip can also be employed when the fastening direction is reversed. This can prevent incorrect mounting.

A preferred embodiment is characterized in that a fastening element is held on the holding section. Preferably, the fastening element has a shank that is held in the receptacle, a head at the end of the shank opposite from the fastening direction, as well as a tip at the end of the shank in the fastening direction. Especially preferably, between the head and the shank, the fastening element has a funnel-shaped, preferably conical, widening section whose outer dimensions crosswise to the fastening direction exceed the inner dimensions of the face opening on the head side. As a result, it is possible for the head to gradually widen or bend open the receptacle.

A preferred embodiment is characterized in that the shank has a thread. Preferably, the thread is suitable for cutting a counter-thread when the fastening element is turned in the receptacle in the fastening direction. This can improve the guidance of the fastening element in the receptacle.

A preferred embodiment is characterized in that the receptacle projects away from the strip crosswise to the fastening direction as well as crosswise to the lengthwise direction of the strip.

A preferred embodiment is characterized in that, in each case, the two adjacent receptacles that are closest to each other are arranged offset with respect to each other in the fastening direction. The offset arrangement of the fastening elements allows the heads of the fastening elements to partially overlap, and therefore, the fastening elements can be packed more tightly along the lengthwise direction of the strip.

A preferred embodiment is characterized in that, in each case, a connecting section is arranged between two holding sections in order to join the holding sections to each other. Preferably, the connecting sections have one or two connecting webs.

A preferred embodiment is characterized in that a plurality of recesses are arranged in the strip, and they can be made to engage with a transport element in order to advance the strip. For this purpose, the recesses are preferably spaced at regular intervals from each other. Preferably, the recesses are each arranged in the lengthwise direction of the strip between two receptacles. Especially preferably, the connecting sections each have a recess, preferably between two connecting webs. Preferably, the recesses are configured as through openings or as indentations.

A preferred embodiment is characterized in that the strip has one or more predetermined breaking points. Preferably, a connecting section has a predetermined breaking point. Especially preferably, each connecting section has a predetermined breaking point. The predetermined breaking points make it easier to cut the strips to length prior to use, in other words, when they are filled with fastening elements, or else after use, in other words, when they are without fastening elements. Preferably, the predetermined breaking points are configured as notches in the strip.

A preferred embodiment is characterized in that the strips are made of hard plastic. Preferably, the strip is stiff enough to be easily transported.

A preferred embodiment is characterized in that each holding section comprises a receptacle having one or more of the above-mentioned advantageous features.

### BRIEF DESCRIPTION OF THE DRAWINGS

Preferred embodiments will be explained in greater detail below making reference to the drawings. These show the following:

FIG. 1 a strip for fastening elements;

FIG. 2 a holding section;

FIG. 3 a strip for fastening elements;

FIG. 4 a strip for fastening elements; and

FIG. 5 a fastening element for snapping into the strip.

### DETAILED DESCRIPTION

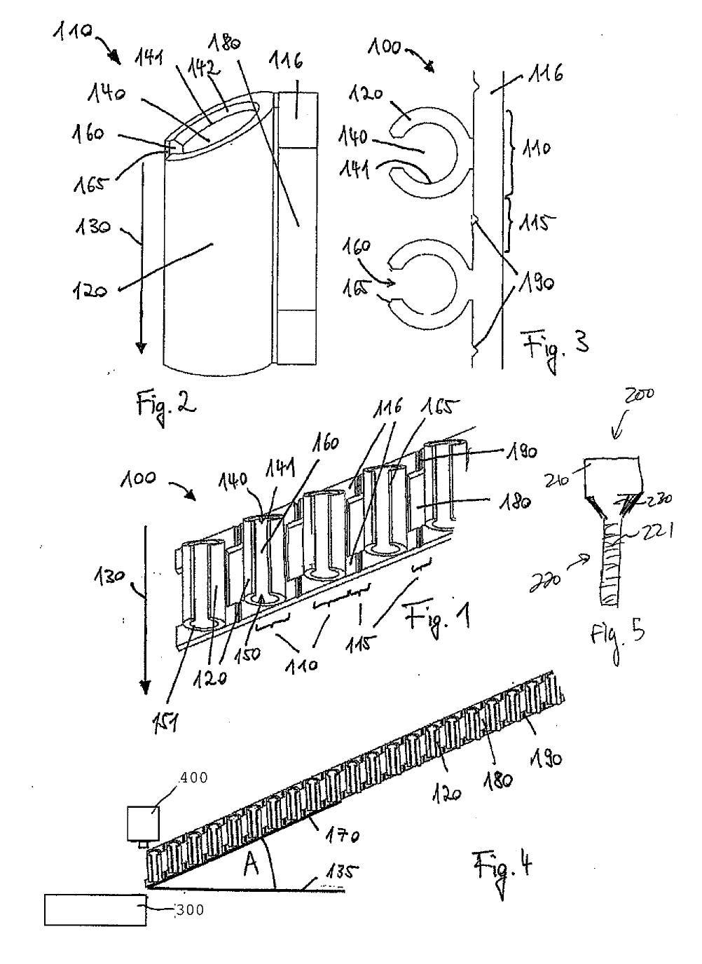

FIG. 1 depicts a slanted view of a strip 100 for fastening elements 200 (FIG. 5), each with a shank 220 and a head 210. The fastening elements preferably have a thread 221 on the shank 220 and a bevel-shaped and conical widening section 230. The strip 100 is made of hard plastic and comprises a plurality of holding sections 110 joined to each other so that each one can temporarily hold a fastening element, as well as connecting sections 115, each arranged between two holding sections, each of which has two connecting webs 116 for joining two adjacent holding sections 116. The fastening elements here are preferably held in their center, in other words, with their center of gravity inside a receptacle 120.

Each holding section 110 here comprises a receptacle 120 for a shank of the fastening element that can be driven out of the receptacle 120 in a fastening direction 130 and into a substrate. The receptacle 120 has a face opening 140 on the head side, as well as a face opening 150 on the tip side, both of which close off the receptacle opposite from or in the fastening direction, whereby an edge 141 of the face opening 140 on the head side is slanted at an acute angle of 60° relative to the fastening direction 130. A preferably funnel-shaped, especially preferably conical, bevel 142 is provided at the edge 141, as a result of which the fastening elements can be individuated more easily. Due to its movement in the fastening direction 130, the fastening element then bends open the receptacle 120 and snaps out of the receptacle 120 with a relatively small amount of force.

The receptacle 120 has a slit 160 that extends continuously over the entire length of the receptacle 120 along the fastening direction 130 and that joins the face opening 140 on the head side and the face opening 150 on the tip side to each other. The edge 141 of the face opening 140 on the head side extends at the same time into the plane of the drawing and opposite from the fastening direction 130. Consequently, the slit 160 is configured on the shorter side of the receptacle 120, since the edge 151 of the face opening 150 on the tip side encloses a right angle with the fastening direction 130. The width of the slit 160 is smaller than the inner diameter of the cylindrical receptacle 120, so that the fastening element can be snapped into the receptacle 120 through the slit 160 and is thus securely held in the receptacle 120. Bevels 165 at the edges of the slit 160 facilitate the snapping into place.

The strip 100 has a continuous strip core that is formed by the connecting sections 115 and by the areas of the holding sections 110 arranged between the connecting sections. The receptacle 120 is arranged outside of the strip core. In particular, the receptacle 120 protrudes from the strip core perpendicular to a strip plane that spans the fastening direction 130 and a lengthwise direction 170 of the strip 100. This makes it easy to select the right material and a suitable material thickness in order to configure the strip 100 stiff enough to ensure that the strip 100 can be easily fed into a fastening device, without having to dispense with the flexibility of the receptacles 120 that is needed for the individuation of the fastening elements, whereby the material of said receptacles 120 is thinner than the core of the strip 100. As can be seen in FIGS. 2 and 3, the receptacle 120 is joined to the strip core by means of a short web. In embodiments not shown here, the receptacle is joined directly to the strip core.

Moreover, the receptacles 120 are offset with respect to each other from one holding section 110 to the next holding section 110 in the fastening direction 130, so that the strip 100 is slanted relative to a fastening plane 135 that is oriented perpendicular to the fastening direction 130. The inclination angle A between the lengthwise direction 170 of the strip 100 and the fastening plane 135 preferably amounts to between 10° and 45°, especially preferably 25°. Due to the offset arrangement of the fastening elements associated with this, their heads overlap partially so that more fastening elements can be held on the strip, while the length of the strip 100 remains the same.

FIG. 4 also shows schematically a substrate 300 and a fastening device 400 for driving the fastening elements 200 into the substrate 300.

Each connecting section 115 has a recess 180 configured as a through opening between the appertaining connecting webs 116, said recess 180 serving to advance the strip 100 in that a transport element, for instance, a toothed wheel, engages with the recesses 180. For this purpose, the recesses 180 are preferably spaced at regular intervals from each other. Therefore, the fastening elements can be positioned in a fastening device without any force being exerted onto the fastening element in question. Such a force-free positioning of the fastening element is advantageous for the driving procedure. Moreover, in the centers of the connecting webs 116, there is a predetermined breaking point configured as a notch 190, so that the strips 100 can easily be cut to length. This cutting to length can be done automatically by a fastening device after each driving procedure, so that no empty strip projects out of the device, since this could hinder the work with such a device.

The present invention was presented with reference to an example of a strip for fastening elements having a shank and a head, especially for a fastening device. However, it must be pointed out that the strip according to the invention is also suitable for other application purposes.

What is claimed is:

1. A strip for fastening elements, each having a shank and a head, the strip comprising:
a plurality of holding sections joined to each other so that each can temporarily hold a fastening element, a first holding section of the plurality of holding sections having a receptacle for a shank of a fastening element, the receptacle defining a fastening direction, a fastening device capable of driving the fastening element out of the receptacle and into a substrate; and
a continuous strip core, the receptacle is arranged outside of the strip core.

2. The strip as recited in claim 1 wherein the receptacle has a face opening on a head side closing off the receptacle opposite from the fastening direction, an edge of the face opening on the head side being slanted at an acute angle with respect to the fastening direction.

3. The strip as recited in claim 2 wherein the edge is slanted away from the strip.

4. The strip as recited in claim 1 wherein the receptacle has a slit that adjoining a face opening on a head side.

5. The strip as recited in claim 4 wherein the slit extends along the fastening direction.

6. The strip as recited in claim 4 wherein the slit is configured in the fastening direction so as to be continuous over the receptacle.

7. The strip as recited in claim 4 wherein an edge of the face opening on the head side extends from the slit opposite from the fastening direction.

8. The strip as recited in claim 1 wherein the fastening element is snappable into the receptacle.

9. The strip as recited in claim 8 wherein the receptacle has a slit and the fastening element is snappable into the slit all the way through the slit.

10. The strip as recited in claim 1 wherein the receptacle is cylindrical.

11. The strip as recited in claim 1 wherein the receptacle has a face opening on a tip side closing off the receptacle in the fastening direction.

12. The strip as recited in claim 11 wherein the face opening adjoins a slit of the receptacle.

13. The strip as recited in claim 1 wherein an edge of the face opening on the tip side is slanted at an acute angle with respect to the fastening direction.

14. The strip as recited in claim 13 wherein the edge is slanted away from the strip.

15. The strip as recited in claim 1 further comprising a fastening element having a shank held in the receptacle.

16. The strip as recited in claim 15 wherein the fastening element has a head at the end of the shank opposite from the fastening direction, and, between the head and the shank, it has a funnel-shaped widening section whose outer dimensions crosswise to the fastening direction exceed the inner dimensions of the face opening on the head side.

17. The strip as recited in claim 16 wherein the funnel-shaped widening section is conical.

18. The strip as recited in claim 16 wherein when the fastening element moves in the fastening direction, the receptacle can be widened.

19. The strip as recited in claim 18 wherein the receptacle can be bent open, by the head or by the widening section.

20. The strip as recited in claim 15 wherein the shank has a thread.

21. The strip as recited in claim 20 wherein the thread is suitable for cutting a counter-thread into the receptacle when the fastening element is turned in the fastening direction.

22. The strip as recited in claim 1 wherein the receptacle projects from the strip crosswise to the fastening direction and crosswise to the lengthwise direction of the strip.

23. The strip as recited in claim 21 wherein the receptacle projects only on one side.
